(19) United States
(12) Patent Application Publication
(10) Pub. No.: US 2002/0196125 A1
(43) Pub. Date: Dec. 26, 2002

(54) Method and apparatus for providing content

(76) Inventors: Philip Shi-Lung Yu, Chappaqua, NY (US); David P. Greene, Ossining, NY (US); Edith H. Stern, Yorktown Heights, NY (US); Barry E. Willner, Briarcliff Manor, NY (US)

Correspondence Address: BUCKLEY, MASCHOFF, TALWALKAR, & ALLISON, 5 ELM STREET, NEW CANAAN, CT, 06840, US

(21) Appl. No.: 09/885,879

(22) Filed: Jun. 20, 2001

(51) Int. Cl. G08B 5/22

(52) U.S. Cl. 340/7.48

(57) ABSTRACT

A system, method, apparatus, and computer program code for providing content. One or more content segments can be identified or selected based on an attribute (e.g., age, location, occupation) of a person. In addition, one or more devices (e.g., computer, cellular telephone, personal digital assistant) associated with the person may be identified or selected. One or more of the content segments can be provided to one or more of the devices for further use or transmittal by the person. The person may transmit or otherwise send one or more of the content segments to people within a localized area or who ask or desire to receive the content segments. In some embodiments, a person may be compensated for receiving and/or broadcasting a content segment.

### FIELD OF THE INVENTION

The present invention relates to a method and apparatus for providing content and, more particularly, embodiments of the present invention relate to methods, apparatus, and computer program code for providing content within a localized area.

### BACKGROUND OF THE INVENTION

In many situations a person may wish to, or be willing to, receive information that is or interest to the person, related to a location, characteristic or interest of the person, or otherwise relevant to the person. For example, a person walking through a mall may want to receive information related to stores in the mall, sales occurring at stores at the mall, etc. while the person is in the mall or a particular store. As another example, a person in a museum may want to receive information regarding a particular painting or piece of sculpture on exhibit at the museum while the person is near the exhibit.

In other situations, providers of content, products or services may want to reach people in localized areas. For example, a restaurant may want people in its vicinity to know of the specials offered by the restaurant, available reservation times, etc. As another example, a company making products targeted to teenagers may want to provide advertisements in localized areas (e.g., rooms, buses) where teenagers are congregating or are at least likely to congregate or otherwise be located.

In such situations, providers of the content (e.g., advertisers, museums) may want to provide the content within a localized area, such as a room. Moreover, the content providers may want to allow people to determine when to receive the content or to select from available content while the people are within the localized area. In addition, the providers may want to allow the people to act as broadcasters or other transmitters of the content within the localized area. For example, a beverage provider may want to allow a person at beach to transmit advertisements for the beverage to other people at the beach.

While some systems, such as the systems disclosed in U.S. Pat. No. 5,732,326 issued to Maruyama et al. and U.S. Pat. No. 5,461,371 issued to Matsumoto et al., both of which are incorporated herein by reference, disclose information systems, neither disclose a system in which content is provided based on an attribute of a person in which the person might broadcast the content to other people, who may be within a localized area.

It would be advantageous to provide a method and apparatus that allowed content to be provided to a person within a localized area that allowed the person to retransmit the content to other people or devices and/or allowed the person to select what content the person wanted to receive. Furthermore, it would be advantageous to provide a method and apparatus that allowed such content to be based on an attribute of a person or device receiving the content.

### SUMMARY OF THE INVENTION

Embodiments of the present invention provide a system, method, apparatus, and computer program code for facilitating the delivery, transmitting or other providing of content. According to embodiments of the present invention, one or more content segments can be identified or selected based on an attribute of a person. In addition, one or more devices (e.g., computer, cellular telephone, personal digital assistant) associated with the person may be identified or selected. One or more content segments can then be provided to one or more of the devices for further use or transmittal by the person. The person may transmit or otherwise send one or more of the content segments to people within a localized area or who ask or desire to receive the content segments. In some embodiments, a person may be compensated for receiving and/or broadcasting a content segment.

An attribute of a person may be or include many things such as, for example, the person's age, occupation, income, educational background or level, race, gender, preferences, medical history, condition or characteristic, employment experience or background, social status, marital status, a characteristic of a group, club, etc. that the person is in or associated with, etc.

A content segment may be or include many things such as, for example, educational content, an advertisement, survey, image, multimedia file, sound or audio file, video file, rich media file, text or other information, etc. A display of a content segment by a device may include an audio component and/or a visual component. Thus, in some embodiments, a device may display a content segment by visually displaying the content segment on a screen. In other embodiments, a device may display a content segment by playing a music, voice or other sound segment or file. In some embodiments, two or more content segments provided to device and/or displayed by a device may be thematically related. For example, two or more of the content segments may related to the same subject such as, a beverage, a restaurant, world geography, a painting, a music selection, automobile repair, botany, basketball, astronomy, scuba diving, Civil War history, etc.

As one example of how a method in accordance with the present invention might be used, a person interested in art history may receive a content segment related to a specific painting. The content segment may include information regarding the history of the painting, the artist, etc. The person receiving the content segment may then rebroadcast or otherwise provide the content segment within a localized area (e.g., a museum room) to others that may be interested in receiving the information about the painting. The person may be in the localized area when the person transmits the content segment. In addition, the person may receive the content segment while the person is in the localized area or prior to the person's arrival at the localized area.

As another example, a teenager may receive several content segments related to companies targeting products to teenagers. The teenager may receive compensation from one or more of the companies if the teenager broadcasts one or more of the content segments while the teenager is at a mall, school, movie theater, arcade, concert or other location at which teenagers are likely to be or congregate.

Additional objects, advantages, and novel features of the invention shall be set forth in part in the description that follows, and in part will become apparent to those skilled in the art upon examination of the following or may be learned by the practice of the invention.

According to embodiments of the present invention, a method for providing content includes determining at least one attribute of a person; determining a content segment based, at least in part, on the at least one attribute of the person; and providing the content segment to a device associated with the person, wherein the device is capable of transmitting the content segment. In another embodiment, a method for providing content includes transmitting at least one signal within a localized area, the at least one signal being indicative of availability of a plurality of content segments within the localized area; and transmitting at least one of the plurality of content segments via a signal within the localized area. In a further embodiment, a method for receiving content includes receiving data indicative of availability of at least one content segment within a localized area; and locating a device within the localized area, wherein the device is capable of receiving a signal indicative of at least one content segment. In yet another embodiment, a method for processing content includes providing data indicative of an attribute; receiving data indicative of a content segment selected, at least in part, on the attribute; and providing data indicative of the content segment within a localized area.

According to one embodiment of the present invention, a system for providing content includes a memory; a communication port; and a processor connected to the memory and the communication port, the processor being operative to determine at least one attribute of a person; determine a content segment based, at least in part, on the at least one attribute of the person; and provide the content segment to a device associated with the person, wherein the device is capable of transmitting the content segment. In another embodiment, the processor may be operative to transmit at least one signal within a localized area, the at least one signal being indicative of availability of a plurality of content segments within the localized area; and transmit at least one of the plurality of content segments via a signal within the localized area. In a further embodiment, the processor may be operative to receive data indicative of availability of at least one content segment within a localized area; and locate a device within the localized area, wherein the device is capable of receiving a signal indicative of at least one content segment. In yet another embodiment, the processor may be operative to provide data indicative of an attribute; receive data indicative of a content segment selected, at least in part, on the attribute; and provide data indicative of the content segment within a localized area.

According to one embodiment of the present invention, an apparatus for providing content includes means for identifying at least one attribute of a person; means for identifying a content segment based, at least in part, on the at least one attribute of the person; and means for sending the content segment to a device associated with the person, wherein the device is capable of transmitting the content segment. In another embodiment, an apparatus for providing content includes means for sending a signal within a localized area, the signal being indicative of availability of a plurality of content segments within the localized area; and means for sending at least one of the plurality of content segments via a signal within the localized area. In a further embodiment, an apparatus for receiving content includes means for obtaining data indicative of availability of at least one content segment within a localized area; and means for identifying a device within the localized area, wherein the device is capable of receiving a signal indicative of at least one content segment. In yet another embodiment, an apparatus for processing content includes means for sending data indicative of an attribute; means for obtaining data indicative of a content segment selected, at least in part, on the attribute; and means for sending data indicative of the content segment with a localized area.

According to one embodiment of the present invention, a computer program product in a computer readable medium for providing content includes first instructions for identifying at least one attribute of a person; second instructions for identifying a content segment based, at least in part, on the at least one attribute of the person; and third instructions for sending the content segment to a device associated with the person, wherein the device is capable of transmitting the content segment. In another embodiment, a computer program product in a computer readable medium for providing content includes first instructions for sending a signal within a localized area, the signal being indicative of availability of a plurality of content segments within the localized area; and second instructions for sending at least one of the plurality of content segments via a signal within the localized area. In a further embodiment, a computer program product in a computer readable medium for receiving content includes first instructions for obtaining data indicative of availability of at least one content segment within a localized area; and second instructions for identifying a device within the localized area, wherein the device is capable of receiving a signal indicative of at least one content segment. In yet another embodiment, a computer program product in a computer readable medium for processing content includes first instructions for sending data indicative of an attribute; second instructions for obtaining data indicative of a content segment selected, at least in part, on the attribute; and third instructions for sending data indicative of the content segment within a localized area.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

The accompanying drawings, which are incorporated in and form a part of the specification, illustrate the preferred embodiments of the present invention, and together with the descriptions serve to explain the principles of the invention.

FIG. 1 is a flowchart of a first embodiment of a method in accordance with the present invention;

FIG. 2 is a flowchart of a second embodiment of a method in accordance with the present invention;

FIG. 3 is a block diagram of system components for an embodiment of an apparatus usable with the methods of FIGS. 1 and 2;

FIG. 4 is a block diagram of components for a server of FIG. 3;

FIG. 5 is an illustration of a representative user information database of FIG. 4;

FIG. 6 is an illustration of a representative user device information database of FIG. 4; and

FIG. 7 is an illustration of a representative content information database of FIG. 4.

### DETAILED DESCRIPTION

Applicants have recognized that there is a need for systems and methods which allow a person to receive content and potentially broadcast or resend the content to people within a localized area or while the person is within a designated or localized area. In addition, applicants have recognized that there is a need to provide systems and methods for allowing a person to receive compensation or other benefits for receiving and/or broadcasting content within a localized area. These and other features will be discussed in further detail below, by describing a system, individual devices, and processes according to embodiments of the invention.

Process Description

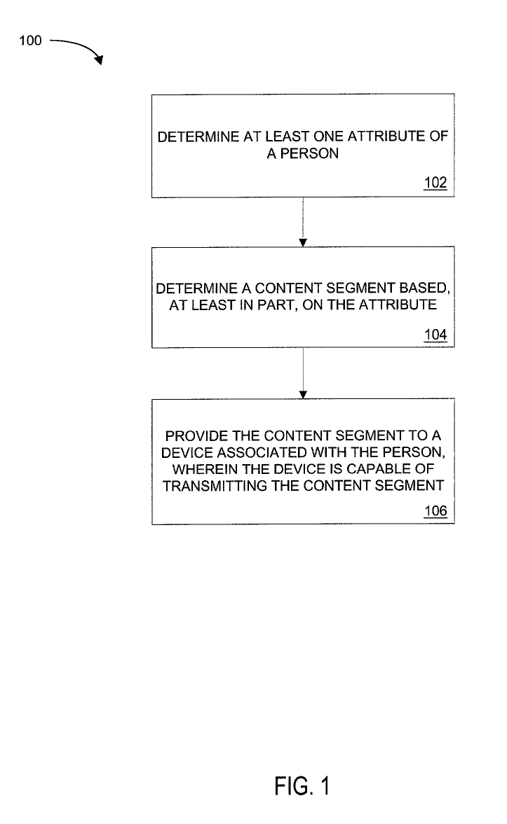

Reference is now made to FIG. 1, where a flow chart 100 is shown which represents the operation of a first embodiment of the present invention. The particular arrangement of elements in the flow chart 100 is not meant to imply a fixed order to the steps; embodiments of the present invention can be practiced in any order that is practicable. In some embodiments, some or all of the steps of the method 100 may be performed or completed by a server, user device and/or another device, as will be discussed in more detail below.

Processing begins at a step 102 during which one or more attributes of a person are determined. An attribute may be or include many things, such as, for example, a location, occupation, marital status, income level, educational experience or background, gender, age, age range, race, travel experience, physical fitness, driving record, criminal record, nationality, citizenship, residence, financial status, investment portfolio, emotional or mental condition, group or club affiliation, accessibility, availability, medical or health condition or history, family size or make-up, height, weight, eye color, hair color, disability, social status, occupation, employment status or history, or other demographic, profile or personal characteristic of the person. In some embodiments, an attribute of a person may be or include a topic of interest to the person, a preference, need or desire of the person, a goal or objective of the person, a hobby of the person, etc.

In some embodiments, the step 102 may or may not include determining the identity of the person. Thus, an attribute of a person may be determined even if the identity or name of the person is not determined or known. For example, an attribute of a person at a company may be the person's length of employment. A content segment may be provided to the person depending on the person's length of employment. The person may use a personal digital assistant (e.g., a Palm VII™ device) to receive training from a central computer or system and provide information regarding the person's length of employment when prompted by the personal digital assistant. A new employee may be provided with a content segment directed to company history, the products and services offered by the company, etc. In contrast, an employee that has been with the company for a year may be provided with a content segment directed to new benefits available to the company, advanced training, etc. The content segments can be provided to the employee even if the employee's specific identity is not known, provided or determined.

In some embodiments, an attribute of a person determined during the step 102 may be a location or other attribute (e.g., technical specification or capability, availability) of a device associated with the person. For example, an attribute of a device may be or include the device's location, storage or memory capacity, transmission capacity, processor speed, accessibility or availability, display capabilities (e.g., ability of the device to display information visually, on a screen, audibly, etc.), etc. In some embodiments, the step 102 or the method 100 may include determining an attribute of a device.

In some embodiments, an attribute of a person determined during the step 102 may be or include an attribute of a device associated with at least one other person associated with the person, an attribute of a device carried by another person in proximity to the person, an attribute of a device associated with at least one other person in proximity to the person, an attribute of at least one other person associated with the person, or an attribute of at least one other person in proximity to the person.

In some embodiments, the step 102 may be or include one or more of the following: receiving data indicative of at least one attribute of a person from the person, a device associated with the person, or some other device or entity; receiving data indicative of at least one attribute and selecting from among a plurality of people at least one person who possesses the attribute; receiving data indicative of a location of a person or a device associated with the person from the person, the device, or some other entity or device; receiving data indicative of a topic of interest to a person; and receiving data indicative of a preference of a person.

In some embodiments, information regarding one or more persons and/or one or more attributes may be stored in, or accessed from, a user information database. In addition, in some embodiments, information regarding one or more devices may be stored in, or accessed from, a device information database.

During a step 104, one or more content segments are determined based, at least in part, on the attribute(s) determined during the step 102. A content segment may be or include many things, such as, for example, educational content, entertainment, training materials, one or more advertisements, a survey, a question or survey, one or more animations, one or more sound or audio files, one or more video clips or files, one or more multimedia files, one or more images, software code, text material, rich media, etc. In some embodiments, information regarding content and content segments may be stored in, or accessed from, a content information database.

As one example of the step 104, a device implementing the method 100 may select different educational materials directed to world geography depending on the person's age, residence or travel experience. As another example, a device implementing the method 100 may select different art history information depending on the person's location (e.g., if the person is in a specific museum, if the person is in proximity to a specific museum), age, personal interests (e.g., is the person more interested in sculpture or old manuscripts), etc.

The step 104 may be or include one or more of the following: receiving data indicative of a selection of the content segment by a person or device, receiving data indicative of a preference for or interest in the content segment by a person, receiving a request or command for a specific content segment, receiving an instruction to provide a specific content segment, providing a person an option of at least two content segments and allowing the person to make a selection from among the at least two content segments, etc.

In some embodiments, one or more rules, procedures, algorithms, functions, heuristics, routines, expert systems, learning systems, conventions, policies, etc. may be determined, selected, received or otherwise established to govern how, how long, when, under what circumstances, etc. a content segment is or may be selected, identified or otherwise determined during the step 104. In some embodiments, the method 100 or the step 104 may include determining a rule, procedure, algorithm, etc. governing selection, storage, use, transmission, etc. of a content segment.

During a step 106, the content segment(s) determined during the step 104 are provided directly or indirectly (e.g., via one or more intermediate devices or people) to a device associated with the person, wherein preferably the device is capable of transmitting the content segment after it receives the content segment. In some embodiments, the device may be a cellular telephone, personal digital assistance, computer or other user device. The step 106 may be or include one or more of the following: sending a notification to the device, the notification including data indicative of the content segment or data (e.g., a link, URL, electronic address) indicative of a location of the content segment; receiving data indicative of the device; identifying or otherwise determining the device, etc.

The device receiving the content segment(s) preferably is capable of transmitting the content segment(s) after the content segment(s) is(are) received or retrieved by the device. In some embodiments, some or all of one or more content segments may be stored on the device. In some embodiments, transmission of a content segment by a device may be or include one or more of the following: broadcasting the content segment within a localized area containing the device; broadcasting the content segment within a localized area containing a specific person; broadcasting the content segment via a Bluetooth compliant device; transmitting the content segment via a wireless signal; wirelessly transmitting or beaming the content segment to another device, etc.

As previously discussed above, the method 100 is particularly well suited for allowing a person with a device to receive a content segment and transmit the content segment to other devices or people within a localized area. In some embodiments, the method 100 or the step 106 may include determining the localized area. In some embodiments, a localized area may be or include a room; an exhibit area; a group of rooms; an area not greater than one hundred and fifty square meters; an area not greater than one-hundred and twenty square meters; an area not greater than seventy-five square meters; an area not greater than fifty square meters; an area not greater than twenty-five square meters; an area not greater than ten square meters, an area not greater than five square meters; an area not greater than one or two square meters, an area surrounding an object, device or person of interest; an area within reception range of a Bluetooth compliant transmission device; an area surrounding a transmitter of the content segment, etc. For example, a person receiving an advertisement (e.g., a content segment) for sun tan location may transmit the advertisement via a wireless signal to other people or devices while the person is at the beach, the wireless signal being of limited signal strength such that it can only be received by people or devices within ten meters of the person. As another example, a person who knows that he or she will be visiting a bookstore later in the day may receive information regarding current best sellers or special deals available at the bookstore and broadcast the information while in the bookstore to other people or devices located in the bookstore.

In some embodiments, the method 100 may include determining or identifying the person for whom the attribute is determined during the step 102. In some embodiments, determining or identifying a person may be or include one or more of the following: receiving a code or other identifier associated with the person; selecting the person from a group of potential recipients of a content segment (e.g., selecting from among a group of people known to visiting a particular location in the future, selecting from among a group of teenagers in the same club or age range); identifying the person from data included in a request to provide a content segment received from the person; selecting the person based, at least in part, on an attribute of at least one device associated with the person; identifying the person based, at least in part, on an request to provide a content segment; receiving a request from the person to provide a content segment; etc. Thus, the person may identify himself or herself when making a request or command for a content segment, or may be identified from the request or command itself (e.g., from an email address or telephone number associated with the request or command, from a device indicated in the request or command that is know to be associated with the person).

As previously mentioned above, in some embodiments the method 100 or one or more of the steps of the method 100 may include determining a device and/or an attribute of a device. In some embodiments the device may be associated with the person for whom the attribute is determined during the step 102. In other embodiments, the device may be associated with another person. In some embodiments, determining a device may be or include one or more of the following: determining a device carried by a person in proximity to, or associated with, the person involved in the step 102; selecting a device from a plurality of devices associated with the person involved in the step 102; selecting a device based, at least in part, on capacity of a communication channel between the device and a provider of a content segment; selecting the device based, at least in part, on the content segment determined during the step 104; selecting a device based, at least in part, on an attribute of the device, etc. For example, a device may be accepted or rejected depending on the ability of the device to receive, transmit and/or store a specific content segment, the accessibility of the device (e.g., a cell phone within range), etc. As another example, a person may have more than one device (e.g., a cellular telephone and a personal digital assistant) associated with him or her, each of which is capable of transmitting a content segment after the content segment is received. The communication channel between a device providing the content segment and the personal digital assistant might be slow relative to the communication channel between the device and the cellular telephone. Thus, the cellular telephone may be selected instead of the personal digital assistant.

In some embodiments, the method 100 or the step 104 may include providing a notification regarding one or more content segments identified during the step 104 to one or more devices and/or persons. A device receiving the notification may be different from the device that receives a content segment as a result of the step 106. Similarly, a person receiving the notification may be different from the person for whom the attribute is determined during the step 102. For example, a device associated with a sponsor of an advertisement (e.g., a content segment) may be notified each time the advertisement is provided to a device that will rebroadcast or retransmit the device. As another example, a person in proximity to a device that receives a content segment as a result of the step 106 may be notified that the content segment is stored on or available from the device.

In some embodiments, a person may receive, or be eligible to receive a benefit or some other compensation for receiving or transmitting a content segment. Compensation may be or include a monetary or non-monetary amount, such as cash, credit, a discount or rebate, frequent flyer miles, long distance calling minutes, etc. For example, a person who transmits an advertisement during a rock concert to other attendees of the rock concert may be entitled to receive ten dollars from the advertiser each time the person transmits the advertisement. In some embodiments, the method 100 may include a step of determining compensation available to a person, providing a notification of the compensation to the person or to some other person or device, and/or providing the compensation.

In some embodiments, the method 100 may include a step of providing a notification to a provider of a content segment when the content segment has been provided to a device during the step 106, transmitted by the device that received the content segment as a result of the step 106, or for some other reason. In some embodiments, a device implementing the method 100 may receive a notification that the content segment sent during the step 106 has been received, stored, located, and/or transmitted. In some embodiments, the method 100 may include confirming the attribute of the person determined during the step 102 or receiving a notification of confirmation of the attribute determined during the step 102.

In some embodiments, one or more rules, procedures, algorithms, functions, heuristics, routines, expert systems, learning systems, conventions, policies, etc. may be determined, selected, received or otherwise established to govern how, how long, when, under what circumstances, etc. a content segment may be used with, received, stored or transmitted by a device. The method 100 may include a step of receiving and/or transmitting a notification regarding such rule, procedure, algorithm, etc.

Any request, command, or other communication or notification described above that may be sent or received, may be in any form or format, including, but not limited to, a HTTP (Hypertext Transfer Protocol), HTML (Hypertext Mark-up Language) or FTP (File Transfer Protocol) transmission, XML (Extensible Mark-up Language) feed, email message, instant message communication, facsimile or radio transmission, telephone call, electronic signal or communication, etc.

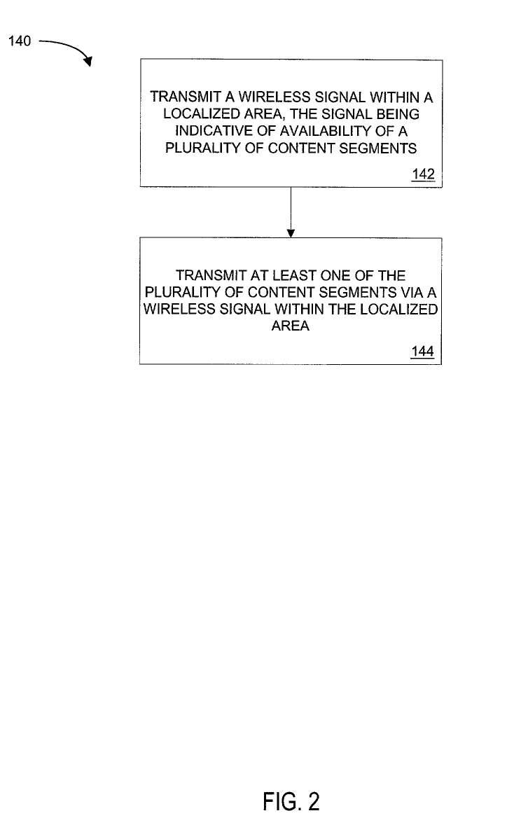

Reference is now made to FIG. 2, where a flow chart 140 is shown which represents the operation of a second embodiment of the present invention. The particular arrangement of elements in the flow chart 140 is not meant to imply a fixed order to the steps; embodiments of the present invention can be practiced in any order that is practicable. In some embodiments, some or all of the steps of the method 140 may be performed or completed by a server, user device and/or another device, as will be discussed in more detail below.

Processing begins at a step 142 during which data or other signal is transmitted within a localized area, the signal being indicative of availability of a plurality of content segments. For example, a wireless signal may be sent from a device implementing the method 140 to people in a shopping mall, the signal containing information regarding two or more additional signals that can be received in the mall, each of the signals being associated with one or more different stores in the mall and providing information regarding products and sales available at the stores.

During a step 142, at least one of the content segments identified during the step 140 is broadcast within a localized area. Using the previous examples, a signal associated with one of the stores in the mall may be transmitted within the store or just outside the store. The signal transmitted during the step 142 may be transmitted continuously or randomly, multiple times during a designated time period, at periodic intervals, etc.

In some embodiments, the method 140 may include a step of receiving a notification regarding a selection of one or more of the content segments indicated during the step 142 or a request to receive one or more of the content segments indicated during the sep 142. For example, a person who receives the signal provided during the step 142 may provide a signal that indicates a content segment of interest to the person or which of the content segments the person wishes to receive during the step 144.

In some embodiments, the method 140 may include one or more of the variations discussed above in reference with the method 100. For example, compensation may be available for receiving, storing or transmitting a content segment.

Other embodiments of the present invention are also possible. For example, a method for receiving content may include receiving data indicative of availability of at least one content segment within a localized area; and locating a device within the localized area, wherein the device is capable of receiving a signal indicative of at least one of the content segments. The signal may be an electromagnetic signal, a non-audible sound signal or some other type of signal. In some embodiments, receiving data indicative of availability of at least one content segment within a localized area may include receiving the data while the device is in the localized area. In some embodiments, the method may include transmitting data indicative of at least one content segment within the localized area; transmitting data indicative of at least one content segment outside the localized area; receiving the data while outside the localized area and transmitting data indicative of the content segment within the localized area; and/or receiving the data while inside the localized area and transmitting data indicative of the content segment within the localized area. In some embodiments, the method may include selecting or otherwise determining at least one content segment, receiving a request for a specific content segment, providing compensation for receiving, storing or sending a content segment, and/or providing a notification of available compensation or a selection of at least one of the content segments. In some embodiments, the method may include one or more of the variations discussed above in reference to the method 100 and/or the method 140.

In a client server environment, variations of the methods disclosed herein also may be implemented from a client perspective. For example, a method for receiving or otherwise processing content may include providing data or other notification indicative of an attribute; receiving data or other notification indicative of a content segment selected, at least in part, on the attribute; and providing data indicative of the content segment within a localized area. This method is similar to the method 100 and may include variations similar to the method 100.

System

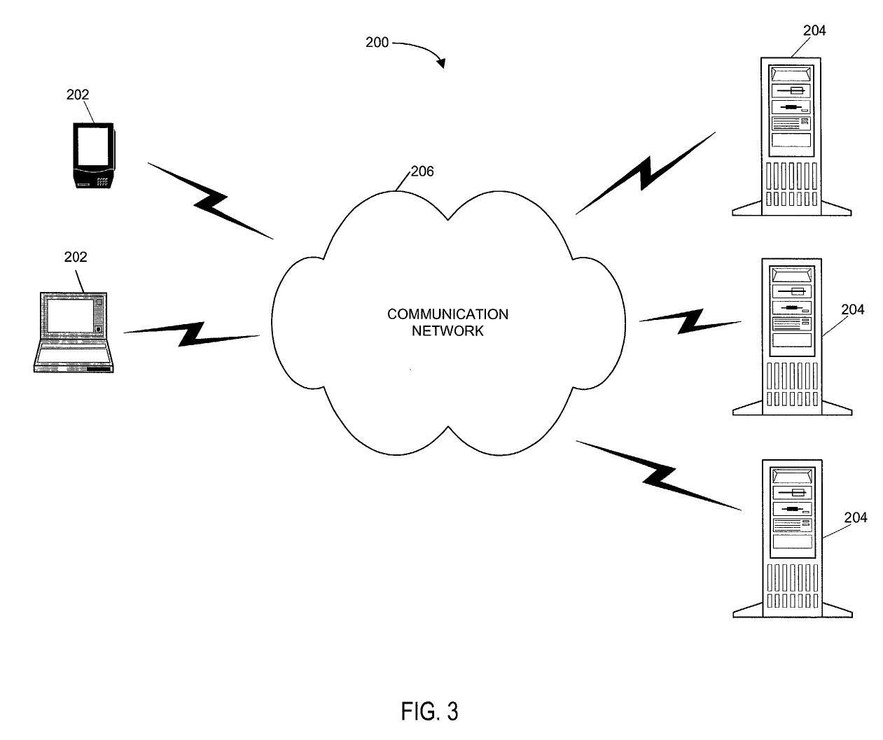

Now referring to FIG. 3, an apparatus or system 200 usable with the methods disclosed herein is illustrated. The apparatus 200 includes one or more user or client devices 202 that may communicate directly or indirectly with one or more servers, controllers or other devices 204 via a computer, data, or communications network 206.

A server 204 may implement or host a Web site. A server 204 can comprise a single device or computer, a networked set or group of devices or computers, a workstation, etc. In some embodiments, a server 204 also may function as a database server and/or as a user device. The use, configuration and operation of servers will be discussed in more detail below.

The user or client devices 202 preferably allow entities to interact with the server 204 and the remainder of the apparatus 200. The user devices 202 also may enable a user to access Web sites, software, databases, etc. hosted or operated by the servers 204. If desired, the user devices 202 also may be connected to or otherwise in communication with other devices. Possible user devices include a personal computer, portable computer, mobile or fixed user station, workstation, network terminal or server, cellular telephone, kiosk, dumb terminal, personal digital assistant, etc.

Many different types of implementations or hardware configurations can be used in the system 200 and with the methods disclosed herein and the methods disclosed herein are not limited to any specific hardware configuration for the system 200 or any of its components.

The communications network 206 might be or include the Internet, the World Wide Web, or some other public or private computer, cable, telephone or communications network or intranet, as will be described in further detail below. The communications network 206 illustrated in FIG. 3 is meant only to be generally representative of cable, computer, telephone or other communication networks for purposes of elaboration and explanation of the present invention and other devices, networks, etc. may be connected to the communications network 206 without departing from the scope of the present invention. The communications network 206 also can include other public and/or private wide area networks, local area networks, wireless networks, data communication networks or connections, intranets, routers, satellite links, microwave links, cellular or telephone networks, radio links, fiber optic transmission lines, ISDN lines, T1 lines, DSL, etc. In some embodiments, a user device may be connected directly to a server 204 without departing from the scope of the present invention. Moreover, as used herein, communications include those enabled by wired or wireless technology.

In some embodiments, a suitable wireless communication network 206 may include the use of Bluetooth technology, allowing a wide range of computing and telecommunication devices to be interconnected via wireless connections. Specifications and other information regarding Bluetooth technology are available at the Bluetooth Internet site www.bluetooth.com. In embodiments utilizing Bluetooth technology, some or all of the devices of FIG. 3 may be equipped with a microchip transceiver that transmits and receives in a previously unused frequency band of 2.45 GHz that is available globally (with some variation of bandwidth in different countries). In addition to data, up to three voice channels are available. Connections can be point-to-point or multipoint over a current maximum range of ten (10) meters. Embodiments using Bluetooth technology may require the additional use of one or more receiving stations to receive and forward data from individual user devices 202 or servers 204.

Although two user devices 202 and three servers 204 are shown in FIG. 3, any number of such devices may be included in the system 200. The devices shown in FIG. 3 need not be in constant communication. For example, a user device may communicate with a server only when such communication is appropriate or necessary.

Server

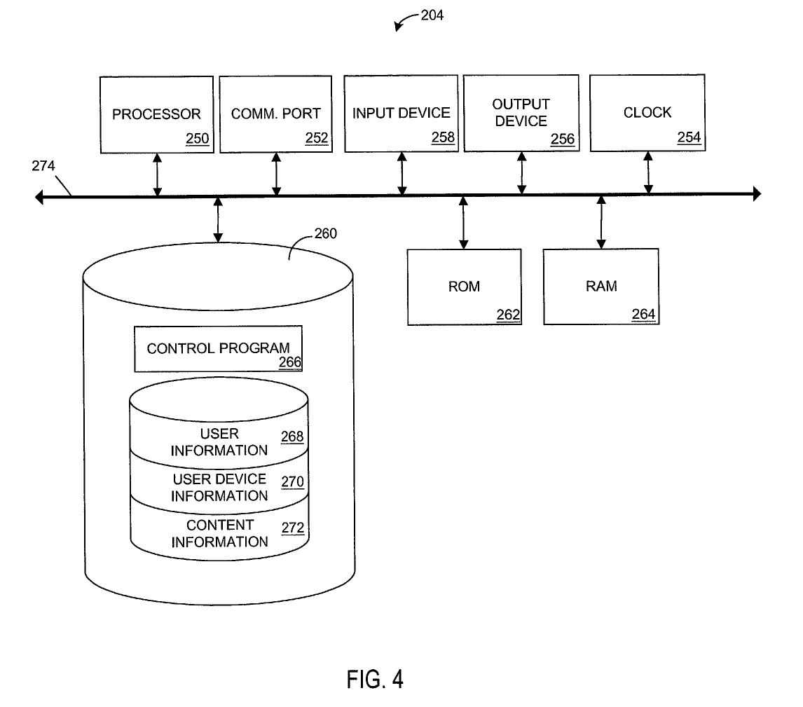

Now referring to FIG. 4, a representative block diagram of a server or controller 204 is illustrated. The server 204 may include a processor, microchip, central processing unit, or computer 250 that is in communication with or otherwise uses or includes one or more communication ports 252 for communicating with user devices and/or other devices. Communication ports may include such things as local area network adapters, wireless communication devices, Bluetooth technology, etc. The server 204 also may include an internal clock element 254 to maintain an accurate time and date for the server 204, create time stamps for communications received or sent by the server 204, etc.

If desired, the server 204 may include one or more output devices 256 such as a printer, infrared or other transmitter, antenna, audio speaker, display screen or monitor, text to speech converter, etc., as well as one or more input devices 258 such as a bar code reader or other optical scanner, infrared or other receiver, antenna, magnetic stripe reader, image scanner, roller ball, touch pad, joystick, touch screen, microphone, computer keyboard, computer mouse, etc.

In addition to the above, the server 204 may include a memory or data storage device 260 to store information, software, databases, communications, device drivers, content, etc. The memory or data storage device 260 preferably comprises an appropriate combination of magnetic, optical and/or semiconductor memory, and may include, for example, Random Read-Only Memory (ROM), Random Access Memory (RAM), a tape drive, flash memory, a floppy disk drive, a Zip™ disk drive, a compact disc and/or a hard disk. The server 204 also may include separate ROM 262 and RAM 264.

The processor 250 and the data storage device 260 in the server 204 each may be, for example: (i) located entirely within a single computer or other computing device; or (ii) connected to each other by a remote communication medium, such as a serial port cable, telephone line or radio frequency transceiver. In one embodiment, the server 204 may comprise one or more computers that are connected to a remote server computer for maintaining databases.

A conventional personal computer or workstation with sufficient memory and processing capability may be used as the server 204. In one embodiment, the server 204 operates as or includes a Web server for an Internet environment. The server 204 preferably is capable of high volume transaction processing, performing a significant number of mathematical calculations in processing communications and database searches. A Pentium™ microprocessor such as the Pentium III™ microprocessor, manufactured by Intel Corporation may be used for the processor 250. Equivalent processors are available from Motorola, Inc., AMD, or Sun Microsystems, Inc. The processor 250 also may comprise one or more microprocessors, computers, computer systems, etc.

Software may be resident and operating or operational on the server 204. The software may be stored on the data storage device 260 and may include a control program 266 for operating the server, databases, etc. The control program 266 may control the processor 250. The processor 250 preferably performs instructions of the control program 266, and thereby operates in accordance with the present invention, and particularly in accordance with the methods described in detail herein. The control program 266 may be stored in a compressed, uncompiled and/or encrypted format. The control program 266 furthermore includes program elements that may be necessary, such as an operating system, a database management system and device drivers for allowing the processor 250 to interface with peripheral devices, databases, etc. Appropriate program elements are known to those skilled in the art, and need not be described in detail herein.

The server 204 also may include or store information regarding users, communications, user devices, content, content providers, etc. For example, information regarding one or more users may be stored in a user information database 268 for use by the server 204 or another device or entity. Information regarding one or more user devices may be stored in a user device information database 270 for use by the server 204 or another device or entity and information regarding content or one or more content segments may be stored in a content information database 272 for use by the server 204 or another device or entity. In some embodiments, one or more of the databases may be stored remotely from the server 204.

According to an embodiment of the present invention, the instructions of the control program may be read into a main memory from another computer-readable medium, such as from the ROM 262 to the RAM 264. Execution of sequences of the instructions in the control program causes the processor 250 to perform the process steps described herein. In alternative embodiments, hard-wired circuitry may be used in place of, or in combination with, software instructions for implementation of some or all of the methods of the present invention. Thus, embodiments of the present invention are not limited to any specific combination of hardware and software.

The processor 250, communication port 252, clock 254, output device 256, input device 258, data storage device 260, ROM 262, and RAM 264 may communicate or be connected directly or indirectly in a variety of ways. For example, the processor 250, communication port 252, clock 254, output device 256, input device 258, data storage device 260, ROM 262, and RAM 264 may be connected via a bus 274.

While specific implementations and hardware configurations for servers 204 have been illustrated, it should be noted that other implementations and hardware configurations are possible and that no specific implementation or hardware configuration is needed. Thus, not all of the components illustrated in FIG. 4 may be needed for a server implementing the methods disclosed herein. Therefore, many different types of implementations or hardware configurations can be used in the system 200 and the methods disclosed herein are not limited to any specific hardware configuration.

User Device

As mentioned above, user device 202 may be or include any of a number of different types of devices, including, but not limited to a personal computer, portable computer, mobile or fixed user station, workstation, network terminal or server, telephone, beeper, kiosk, dumb terminal, personal digital assistant, facsimile machine, two-way pager, radio, cable set-top box, cash register, etc. If desired, the user device 202 also may function as a server 204 and/or as a content server.

In some embodiments, a user device 202 may have the same structure or configuration as the server 204 illustrated in FIG. 4 and include some or all of the components of the server 204. In some embodiments, a user device 202 may include one or more output devices such as a printer, infrared or other transmitter, antenna, audio speaker, display screen or monitor, text to speech converter, etc. to be able to broadcast, send, transmit or otherwise provide a content segment or other communications. In some embodiments, a user device 202 may include one or more input devices such as a bar code reader or other optical scanner, infrared or other receiver, antenna, magnetic stripe reader, image scanner, roller ball, touch pad, joystick, touch screen, microphone, computer keyboard, computer mouse, etc. to detect or otherwise receive a content segment or other communications.

Databases

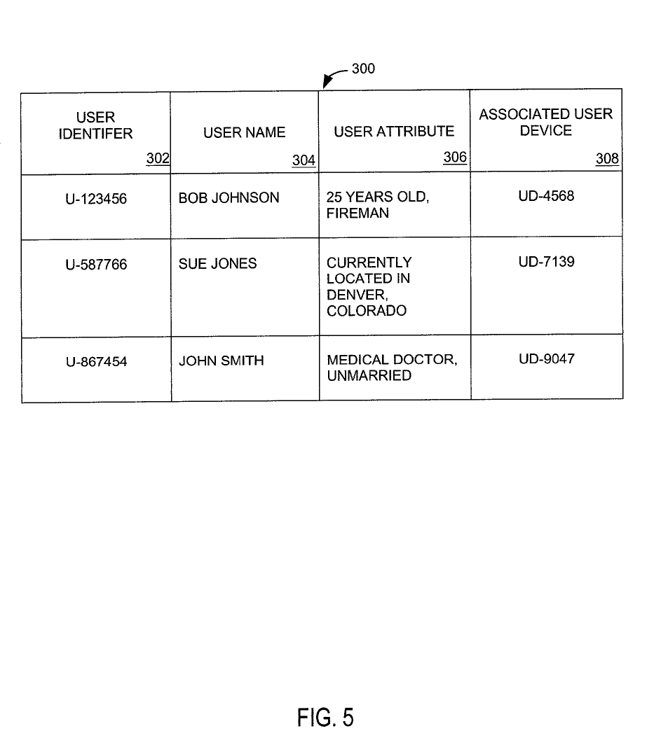

As previously discussed above, in some embodiments a server, user device, or other device may include or access a user information database for storing or keeping information regarding one or more users. One representative user information database 300 is illustrated in FIG. 5.

The user information database 300 may include a user identifier field 302 that may include codes or other identifiers for one or more users, a user name field 304 that may include names or other information for the users identified in the field 302, a user attribute field that may include information regarding characteristics or other attributes of the users identified in the field 302, and an associated user device field 308 that may include codes or other identifiers for one or more user devices associated with the users identified in the field 302. A user may be associated with more than one user device and a user device may be associated with more than one user.

Other or different fields also may be used in the user information database 300. For example, in some embodiments, the user information database 300 may include one or more fields that contain postal or electronic (e.g., email) address or other contact information for the users identified in the field 302. In some embodiments, the user information database 300 may include fields that contain specific attribute information for users such as, for example, the users' age, gender, occupation, residence, current location, marital status, income, hobbies, preferences, etc.

As illustrated by the user information database of FIG. 5, the user identified as “U-123456” in the field 302 is named “BOB JOHNSON”, is twenty-five years old and a fireman. In addition, the user identified as “U-123456” in the field 302 is associated with a user device identified as “UD-4568” in the field 308. In some embodiments, information regarding user devices may be found in a user device information database. As another example, the user identified as “U-587766” in the field 302 is named “SUE JONES”, is currently located in Denver, Colo., and is associated with the user device identified as “UD-7139”.

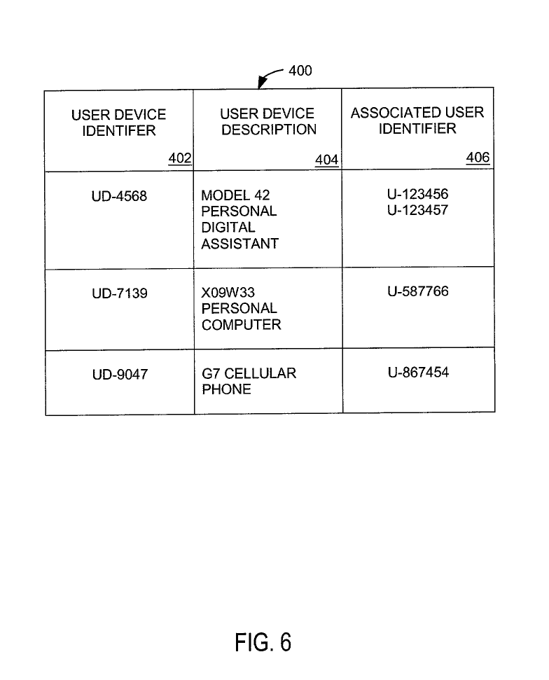

As previously discussed above, in some embodiments a server, user device, or other device may include or access a user device information database for storing or keeping information regarding one or more user devices. One representative user device database 00 is illustrated in FIG. 6.

The user device information database 400 may include a user device identifier field 402 that may include codes or other identifiers for one or more user devices, a user device description field 404 that may include names or other descriptive information for the user devices identified in the field 402, and an associated user identifier field 406 that may include codes or other identifiers for one or more users associated with the user devices identified in the field 402. Other or different fields also may be used in the user device information database 400. For example, in some embodiments, the user device information database 400 may include a field that indicates current or expected availability, if known, for one or more of the user devices identified in the field 402. As another example, in some embodiments, the user device information database 400 may include a communication field that may include passwords, telephone numbers, email addresses, etc. that indicate how best to contact the user devices identified in the field 402.

As illustrated in the user device information database 400, the user device identified as “UD-4568” is a “MODEL 42 PERSONAL DIGITAL ASSISTANT” and is associated with the user identified as “U-123456” and the user identified as “U-123457”. The user device identified as “UD-7139” is a “X09W33 PERSONAL COMPUTER” and is associated with the user identified as “U-587766”. A user device may be associated with more than one user and a user may be associated with more than one user device.

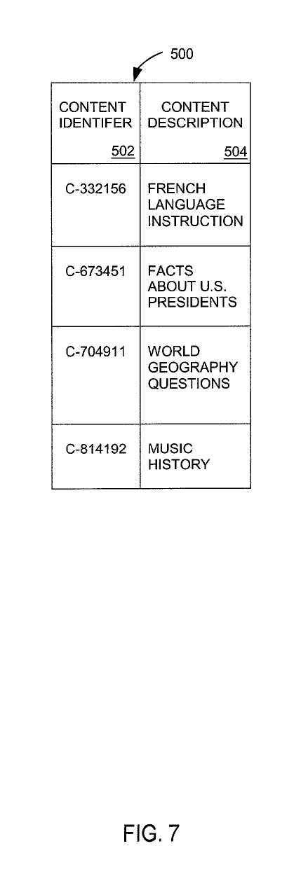

As previously discussed above, in some embodiments a server, user device, or other device may include or access a content information database for storing or keeping information regarding content and one or more content segments. One representative content information database 500 is illustrated in FIG. 7.

The content information database 500 may include a content or content segment identifier field 502 that may include codes or other identifiers for content or one or more content segments and a content description field 504 that may include names and other descriptive information for the content identified in the field 502. Other or different fields also may be used in the content information database 500. For example, in some embodiments, the content information database may include a field that includes information regarding the format (e.g., text only, rich media) of the content identified in the field 502, a field that includes information regarding memory or other operational or technical requirements for the content identified in the field 502, and/or a field that includes information regarding one or more rules, heuristics, algorithms, procedures, etc. governing or monitoring how, when, how long, under what circumstances, etc. content identified in the field 502 is to be transmitted or otherwise made available. As illustrated in the content information database 500 of FIG. 7, the content identified as “C-332156” is “FRENCH LANGUAGE INSTRUCTION” while the content identified as “C-673451” includes “FACTS ABOUT U.S. PRESIDENTS”.

The methods of the present invention may be embodied as a computer program developed using an object oriented language that allows the modeling of complex systems with modular objects to create abstractions that are representative of real world, physical objects and their interrelationships. However, it would be understood by one of ordinary skill in the art that the invention as described herein could be implemented in many different ways using a wide range of programming techniques as well as general-purpose hardware systems or dedicated controllers. In addition, many, if not all, of the steps for the methods described above are optional or can be combined or performed in one or more alternative orders or sequences without departing from the scope of the present invention and the claims should not be construed as being limited to any particular order or sequence, unless specifically indicated.

Each of the methods described above can be performed on a single computer, computer system, microprocessor, etc. In addition, two or more of the steps in each of the methods described above could be performed on two or more different computers, computer systems, microprocessors, etc., some or all of which may be locally or remotely configured. The methods can be implemented in any sort or implementation of computer software, program, sets of instructions, code, ASIC, or specially designed chips, logic gates, or other hardware structured to directly effect or implement such software, programs, sets of instructions or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, Zip™ disk, flash or optical memory card, microprocessor, solid state memory device, RAM, EPROM, or ROM.

Although the present invention has been described with respect to a preferred embodiment thereof, those skilled in the art will note that various substitutions may be made to those embodiments described herein without departing from the spirit and scope of the present invention.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof.

The embodiments of the invention in which an exclusive property or privilege is claimed are defined as follows:

1. A method for providing content, comprising:
determining at least one attribute of a person;
determining a content segment based, at least in part, on said at least one attribute of said person; and
providing said content segment to a device associated with said person, wherein said device is capable of transmitting said content segment.

2. The method of claim 1, wherein said determining at least one attribute of a person includes at least one of the following:
receiving data indicative of said at least one attribute;
receiving data indicative of said at least one attribute and selecting from among a plurality of people at least one person who possesses said attribute;
receiving data indicative of a location of said person;
receiving data indicative of a location of said device;
receiving data indicative of a topic of interest to said person; and
receiving data indicative of a preference of said person.

3. The method of claim 1, wherein said determining a content segment based, at least in part, on said at least one attribute includes at least one of the following:
receiving a request for a specific content segment;
receiving a command for a specific content segment;
receiving an instruction to provide a specific content segment;
receiving data indicative of a selection of said content segment by said person;
receiving data indicative of a selection of said content segment by said device;
receiving data indicative of a preference for said content segment by said person; and
providing said person an option of at least two content segments and allowing said person to make a selection from among said at least two content segments.

4. The method of claim 1, wherein said providing said content segment to a device associated with said person includes at least one of the following:
sending a notification to said device, said notification including data indicative of said content segment;
sending a notification to said device, said notification including data indicative of a location of said content segment;
receiving data indicative of said device; and
determining said device.

5. The method of claim 1, wherein said transmitting said content segment includes at least one of the following:
broadcasting said content segment within a localized area containing said device;
broadcasting said content segment within a localized area containing said person;
broadcasting said content segment via a Bluetooth compliant device;
transmitting said content segment via a wireless signal; and
wirelessly transmitting said content segment to another device.

6. The method of claim 1, wherein said attribute of said person includes at least one of the following:
a location of said person;
a location of said device;
a citizenship of said person;
a nationality of said person;
a residence of said person;
a preference of said person;
a topic of interest to said person;
travel experience of said person;
an occupation of said person;
a marital status of said person;
an income level of said person;
an educational background of said person;
a group said person is affiliated with;
an employment status of said person;
a gender of said person;
a race of said person;
age of said person;
an age range that includes an age of said person;
a medical history of said person;
a medical condition of said person;
a social status of said person;
a demographic characteristic of said person;
a demographic profile of said person;
an attribute of a device associated with said person;
an attribute of a device associated with at least one other person associated with said person;
an attribute of a device carried by another person in proximity to said person;
an attribute of a device associated with at least one other person in proximity to said person.
an attribute of at least one other person associated with said person; and
an attribute of at least one other person in proximity to said person.

7. The method of claim 1, wherein said content segment includes at least one of the following:
educational content;
entertainment;
training materials;
an advertisement;
a survey;
a question;
an animation;
a sound file;
a video clip;
a multimedia file;
an image;
software code;
text material; and
rich media.

8. The method of claim 1, further comprising:
determining said localized area.

9. The method of claim 1, further comprising:
providing a notification of said content segment to a second device.

10. The method of claim 1, further comprising:
providing a notification of said content segment to a second person.

11. The method of claim 1, further comprising:
determining an attribute of said device.

12. The method of claim 1, where in said attribute of said device includes at least one of The following:
accessibility of said device;
availability of said device;
operational speed of said device;
a display capability of said device;
storage capacity of said device; and
transmission capability of said device.

13. The method of claim 1, further comprising:
determining said device.

14. The method of claim 13, wherein said determining said device includes at least one of the following:
determining a device carried by a person in proximity to said person;
determining a device associated with a person associated with said person;
selecting said device from a plurality of devices associated with said person;
selecting said device based, at least in part, on capacity of a communication channel to said device;
selecting said device based, at least in part, on said content segment; and
selecting said device based, at least in part, on an attribute of said device.

15. The method of claim 1, further comprising:
determining said person.

16. The method of claim 15, wherein said determining said person includes at least one of the following:
receiving an identifier associated with said person;
selecting said person from a group of potential recipients of a content segment;
identifying said person from data included in a request to provide a content segment;
selecting said person based, at least in part, on an attribute of at least one device associated with said person;
identifying said person based, at least in part, on an request to provide a content segment; and
receiving a request from said person to provide a content segment.

17. The method of claim 1, wherein said device is a user device.

18. The method of claim 1, further comprising:
determining compensation available to said person.

19. The method of claim 18, further comprising:
providing a notification regarding said compensation.

20. The method of claim 1, further comprising:
providing said compensation.

21. The method of claim 1, wherein said localized area includes at least one of the following:
a room;
a plurality of rooms;
an area not greater than one hundred and fifty square meters;
an area not greater than one-hundred and twenty square meters;
an area not greater than seventy-five square meters;
an area not greater than fifty square meters;
an area not greater than twenty-five square meters;
an area not greater than ten square meters;
an area not greater than five square meters;
an area not greater than two square meters;
an area not greater than one square meter;
an area surrounding a device;
an area surrounding an object;
an area surrounding a person;
an area within reception range of a Bluetooth compliant transmission device; and
an area surrounding a transmitter of said content segment.

22. The method of claim 1, further comprising:
determining an identity of said person.

23. The method of claim 1, further comprising:
determining a rule governing transmission of said content segment by said device.

24. The method of claim 1, further comprising:
receiving confirmation of said attribute.

25. The method of claim 1, further comprising:
receiving a notification that said content segment has been received by said device.

26. The method of claim 1, further comprising:
receiving a notification that said content segment has been transmitted by said device.

27. A method for providing content, comprising:
transmitting at least one wireless signal within a localized area, said at least one signal being indicative of availability of a plurality of content segments within said localized area; and
transmitting at least one of said plurality of content segments via a wireless signal within said localized area.

28. The method of claim 27, wherein said localized area includes at least one of the following:
a room;
a plurality of rooms;
an area not greater than one hundred and fifty square meters;
an area not greater than one-hundred and twenty square meters;
an area not greater than seventy-five square meters;
an area not greater than fifty square meters;
an area not greater than twenty-five square meters;
an area not greater than ten square meters;
an area not greater than five square meters;
an area not greater than two square meters;
an area not greater than one square meter;
an area surrounding a device;
an area surrounding an object;
an area surrounding a person;
an area within reception range of a Bluetooth compliant transmission device; and
an area surrounding a transmitter of said content segment.

29. The method of claim 27, wherein said localized area is a room.

30. The method of claim 27, further comprising:
receiving a notification regarding a selection of one of said plurality of content segments.

31. The method of claim 27, further comprising:
receiving a request to transmit at least one of said plurality of content segments.

32. The method of claim 27, wherein transmitting at least one of said plurality of content segments via a wireless signal within said localized area includes transmitting said at least one of said plurality of content segments via a wireless signal at least twice during a designated time period.

33. A method for receiving content, comprising:
receiving data indicative of availability of at least one content segment within a localized area; and
locating a device within said localized area, wherein said device is capable of receiving a signal indicative of said at least one of said at least one content segment.

34. The method of claim 33, wherein said receiving data indicative of availability of at least one content segment within a localized area includes receiving said data while said device is in said localized area.

35. The method of claim 33, further comprising:
transmitting data indicative of said at least one content segment within said localized area;
transmitting data indicative of said at least one content segment outside said localized area;
receiving said data while outside said localized area and transmitting data indicative of said content segment within said localized area; and
receiving said data while inside said localized area and transmitting data indicative of said content segment within said localized area.

36. The method of claim 33, further comprising:
selecting said at least one of said at least one content segment.

37. The method of claim 33, wherein said signal is one of the following:
an electromagnetic signal; and
an non-audible sound signal.

38. The method of claim 33, further comprising:
providing a notification of a selection of said at least one of said at least one content segment.

39. The method of claim 33, wherein said localized area includes at least one of the following:
a room;
a plurality of rooms;
an area not greater than one hundred and fifty square meters;
an area not greater than one-hundred and twenty square meters;
an area not greater than seventy-five square meters;
an area not greater than fifty square meters;
an area not greater than twenty-five square meters;
an area not greater than ten square meters;
an area not greater than five square meters;
an area not greater than two square meters;
an area not greater than one square meter;
an area surrounding a device;
an area surrounding an object;
an area surrounding a person;
an area within reception range of a Bluetooth compliant transmission device; and
an area surrounding a transmitter of said content segment.

40. A method for processing content, comprising:
providing data indicative of an attribute;
receiving data indicative of a content segment selected, at least in part, on said attribute; and
providing data indicative of said content segment within a localized area.

41. A system for providing content, comprising:
a memory;
a communication port; and
a processor connected to said memory and said communication port, said processor being operative to:
determine at least one attribute of a person;
determine a content segment based, at least in part, on said at least one attribute of said person; and
provide said content segment to a device associated with said person, wherein said device is capable of transmitting said content segment.

42. A computer program product in a computer readable medium for providing content, comprising:
first instructions for identifying at least one attribute of a person;
second instructions for identifying a content segment based, at least in part, on said at least one attribute of said person; and
third instructions for sending said content segment to a device associated with said person, wherein said device is capable of transmitting said content segment.
